(19) United States
(12) Patent Application Publication
(10) Pub. No.: US 2016/0179739 A1
(43) Pub. Date: Jun. 23, 2016

(54) SYMMETRICALLY COUPLED DIFFERENTIAL CHANNEL

(71) Applicant: Intel Corporation, Santa Clara, CA (US)

(72) Inventors: Jonggab Kil, El Dorado Hills, CA (US); Ravindra Rudraraju, Folsom, CA (US); Edward W. Gong, Elk Grove, CA (US)

(21) Appl. No.: 14/574,374

(22) Filed: Dec. 17, 2014

(51) Int. Cl. G06F 13/42; G05F 1/625

(52) U.S. Cl. CPC G06F 13/4221; G05F 1/625

(57) ABSTRACT

A stream of binary data is converted into a stream of symbols according to a three-phase encoding scheme and send the symbols on a physical link. The link includes one or more lanes, each lane including a set of three conductors. The set of three conductors are to be oriented so that each conductor in the set is equidistant from the other two conductors in the set.

### FIELD

The present disclosure relates in general to the field of computer communications, and more specifically, to facilitating communication between hardware components.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc.

As a result of the greater ability to fit more processing power in smaller packages, smaller computing devices have increased in popularity. Smartphones, tablets, ultrathin notebooks, and other user equipment have grown exponentially. However, these smaller devices are reliant on servers both for data storage and complex processing that exceeds the form factor. Consequently, the demand in the high-performance computing market (i.e. server space) has also increased. For instance, in modern servers, there is typically not only a single processor with multiple cores, but also multiple physical processors (also referred to as multiple sockets) to increase the computing power. But as the processing power grows along with the number of devices in a computing system, the communication between sockets and other devices becomes more critical.

In fact, interconnects have grown from more traditional multi-drop buses that primarily handled electrical communications to full blown interconnect architectures that facilitate first communication. Unfortunately, as the demand for future processors to consume at even higher-rates corresponding demand is placed on the capabilities of existing interconnect architectures.

### BRIEF DESCRIPTION OF THE DRAWINGS

FIG. 1 illustrates a simplified block diagram of a system including a serial point-to-point interconnect to connect I/O devices in a computer system in accordance with one embodiment;

FIG. 2 illustrates a simplified block diagram of a layered protocol stack in accordance with one embodiment;

FIG. 3 illustrates an embodiment of a serial point-to-point link.

FIG. 4 illustrates an embodiment of a lane module.

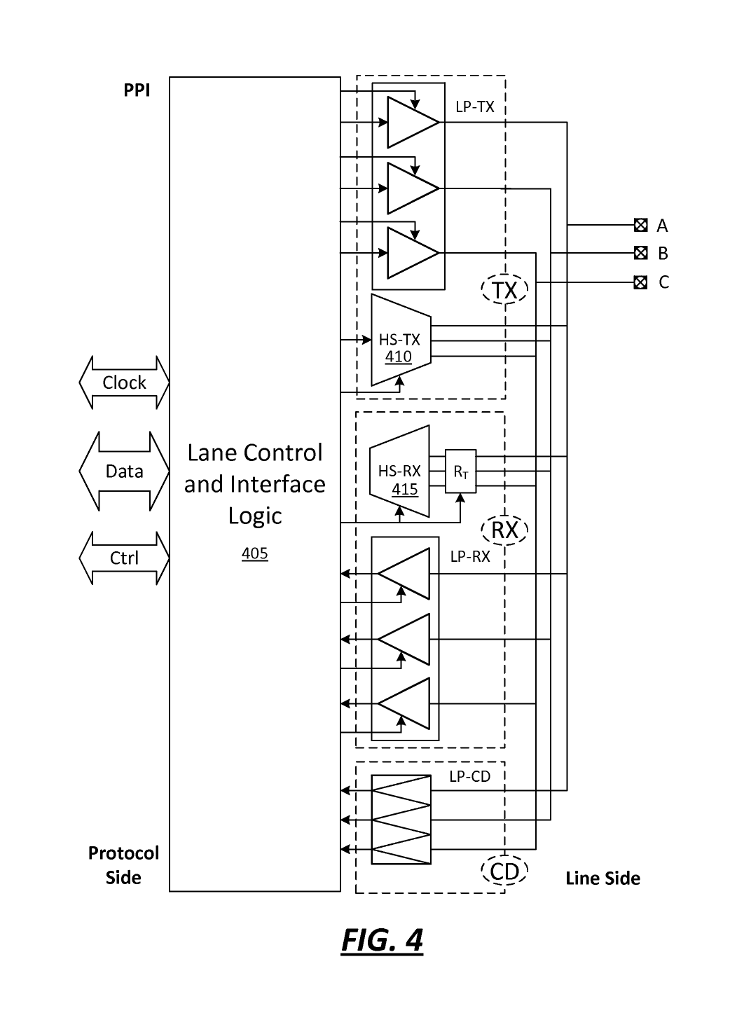

FIG. 5 illustrates example techniques for sending data using three-phase encoding.

FIG. 6 illustrates an embodiment of a three signal-trio.

FIG. 7A illustrates a cross-sectional view of an example, conventional stack up orientation of a three-wire lane.

FIG. 7B illustrates a cross-sectional view of an example symmetrically-coupled stack up orientation of a three-wire lane.

FIGS. 8A-8E illustrate comparisons of two alternate lane orientations during five wire state transitions.

FIGS. 9A-9B illustrate example eye diagrams.

FIG. 10 illustrates an embodiment of a block for a computing system including multiple processor sockets.

FIG. 11 illustrates another embodiment of a block diagram for a computing system.

Like reference numbers and designations in the various drawings indicate like elements.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific processor pipeline stages, specific interconnect layers, specific packet/transaction configurations, specific transaction names, specific protocol exchanges, specific link widths, specific implementations, and operation etc. in order to provide a thorough understanding of the present invention. It may be apparent, however, to one skilled in the art that these specific details need not necessarily be employed to practice the subject matter of the present disclosure. In other instances, well detailed description of known components or methods has been avoided, such as specific and alternative processor architectures, specific logic circuits/code for described algorithms, specific firmware code, low-level interconnect operation, specific logic configurations, specific manufacturing techniques and materials, specific compiler implementations, specific expression of algorithms in code, specific power down and gating techniques/logic and other specific operational details of computer system in order to avoid unnecessarily obscuring the present disclosure.

Although the following embodiments may be described with reference to energy conservation, energy efficiency, processing efficiency, and so on in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from such features. For example, the disclosed embodiments are not limited to server computer system, desktop computer systems, laptops, Ultrabooks™, but may be also used in other devices, such as handheld devices, smartphones, tablets, other thin notebooks, systems on a chip (SOC) devices, and embedded applications. Some examples of handheld devices include cellular phones, Internet protocol devices, digital cameras, personal digital assistants (PDAs), and handheld PCs. Here, similar techniques for a high-performance interconnect may be applied to increase performance (or even save power) in a low power interconnect. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As may become readily apparent in the description below, the embodiments of methods, apparatus', and systems described herein (whether in reference to hardware, firmware, software, or a combination thereof) may be considered vital to a “green technology” future balanced with performance considerations.

As computing systems are advancing, the components therein are becoming more complex. The interconnect architecture to couple and communicate between the components has also increased in complexity to ensure bandwidth demand is met for optimal component operation. Furthermore, different market segments demand different aspects of interconnect architectures to suit the respective market. For example, servers require higher performance, while the mobile ecosystem is sometimes able to sacrifice overall performance for power savings. Yet, it is a singular purpose of most fabrics to provide highest possible performance with maximum power saving. Further, a variety of different interconnects can potentially benefit from subject matter described herein.

The MIPI PHY architecture, Peripheral Component Interconnect (PCI) Express (PCIe) interconnect fabric architecture, QuickPath Interconnect (QPI) fabric architecture, Universal Serial Bus (USB) architecture, among other examples, can potentially be improved according to one or more principles described herein, among other examples. For instance, high speed data channels can be realized with improvements in noise, cross talk, and insertion loss, among other example benefits.

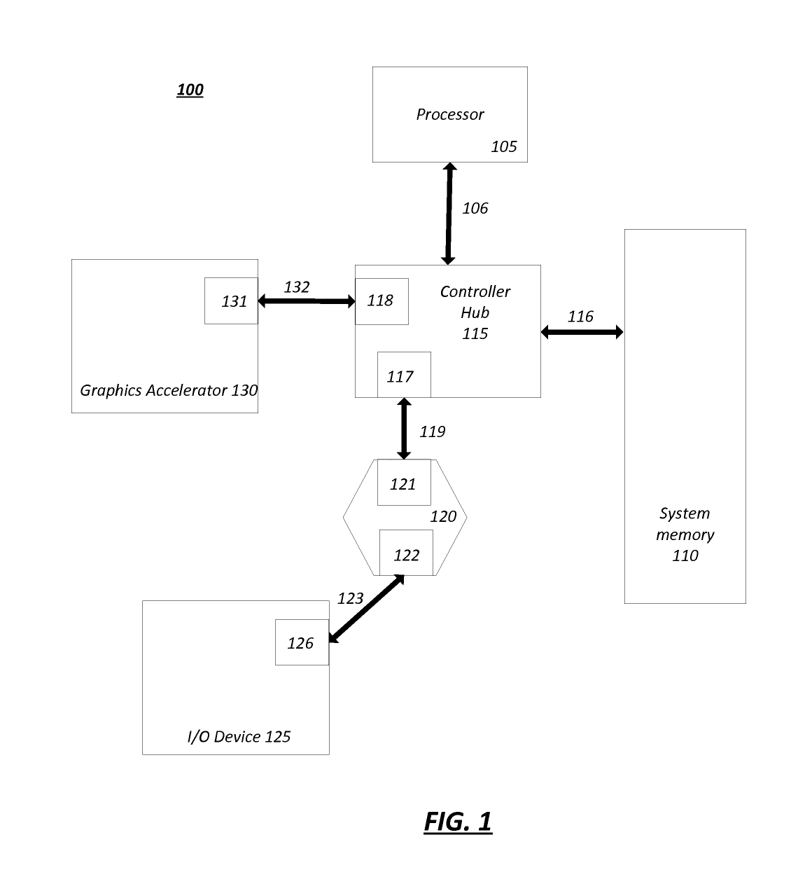

Referring to FIG. 1, an embodiment of a fabric composed of point-to-point Links that interconnect a set of components is illustrated. System 100 includes processor 105 and system memory 110 coupled to controller hub 115. Processor 105 can include any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 can include a root hub, root complex, or root controller, such as in a PCIe interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, e.g., a memory controller huh (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, can include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual bridge devices (e.g., PCI-to-PCI bridge devices). Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a bridge (e.g., a PCIe to PCI/PCI-X bridge) to support legacy or other versions of devices or interconnect fabrics supported by such devices.

Graphics accelerator 130 can also be coupled to controller hub 115 through serial link 132. In one embodiment, graphics accelerator 130 is coupled to an MCH, which is coupled to an ICH. Switch 120, and accordingly I/O device 125, is then coupled to the ICH, I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105.

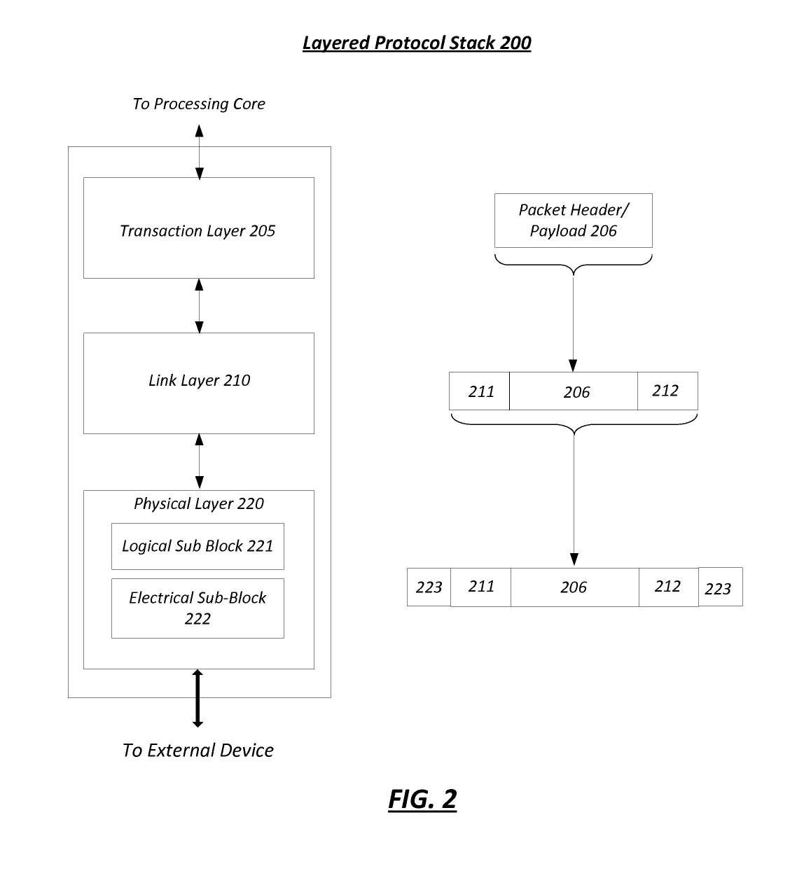

Turning to FIG. 2 an embodiment of a layered protocol stack is illustrated. Layered protocol stack 200 can includes any form of a layered communication stack, such as a QPI stack, a PCIe stack, a stack implementing a MIPI PHY as a physical layer, a next generation high performance computing interconnect (HPI) stack, or other layered stack. In one embodiment, protocol stack 200 can include transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

Packets can be used to communicate information between components. Packets, in some implementations, can be formed in the Transaction Layer 205 and Data. Link Layer 210 to carry the information from the transmitting component to the receiving component. As the transmitted packets flow through the other layers, they are extended with additional information used to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

In one embodiment, transaction layer 205 can provide an interface between a device's processing core and the interconnect architecture, such as Data Link Layer 210 and Physical Layer 220. In this regard, a primary responsibility of the transaction layer 205 can include the assembly and disassembly of packets (i.e., transaction layer packets, or TLPs). In some systems, the translation layer 205 can also manage credit-based flow control for TLPs. In some implementations, split transactions can be utilized, i.e., transactions with request and response separated by time, allowing a link to carry other traffic while the target device gathers data for the response, among other examples.

Credit-based flow control can be used to realize virtual channels and networks utilizing the interconnect fabric. In one example, a device can advertise an initial amount of credits for each of the receive buffers in Transaction Layer 205. An external device at the opposite end of the link, such as controller hub 115 in FIG. 1, can count the number of credits consumed by each TLP. A transaction may be transmitted if the transaction does not exceed a credit limit. Upon receiving a response an amount of credit is restored. One example of an advantage of such a credit scheme is that the latency of credit return does not affect performance, provided that the credit limit is not encountered, among other potential advantages.

A Link layer 210, also referred to as data link layer 210 in some implementations, can act as an intermediate stage between transaction layer 205 and the physical layer 220. In one embodiment, a responsibility of the data link layer 210 is providing a reliable mechanism for exchanging Transaction Layer Packets (TLPs) between two components on a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

In one example, physical layer 220 includes logical sub block 221 and electrical sub-block 222 to physically transmit a packet to an external device. Here, logical sub-block 221 is responsible for the “digital” functions of Physical Layer 221. In this regard, the logical sub-block can include a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221

As stated above, although transaction layer 205, link layer 210, and physical layer 220 are discussed in reference to a specific embodiment of a protocol stack (such as a PCIe protocol stack), a layered protocol stack is not so limited. In fact, any layered protocol may be included/implemented and adopt features discussed herein. As an example, a port/interface that is represented as a layered protocol can include: (1) a first layer to assemble packets, i.e. a transaction layer; a second layer to sequence packets, i.e. a link layer; and a third layer to transmit the packets, i.e. a physical layer. As a specific example, a high performance interconnect layered protocol, as described herein, is utilized.

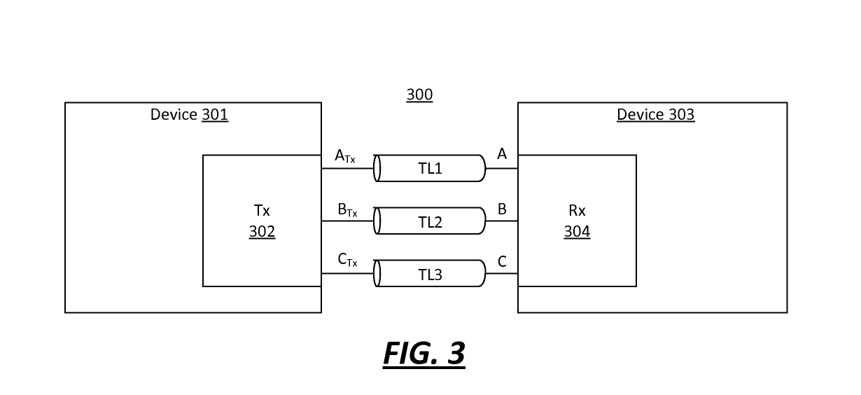

Referring next to the block diagram of FIG. 3, in one embodiment, computing system 300 includes device 301 having transmitter (Tx) 302. device 303 having receiver (Rx) 304, and three transmission lines (TLs) TL1-TL3. The three transmission lines can be utilized in connection with a 3-phase symbol encoding technology for delivering high bits per symbol over three wire trios—TL1, TL2, and TL3. Here, Tx 302 transmits three signals A_{Tx}, B_{Tx}, and C_{Tx} over the transmission lines to Rx 304. The voltage levels on the three TLs (i.e., TL1, TL2, and TL3) at the input of Rx 304 are V_{A}, V_{B}, and V_{C}, respectively. Here, voltage levels V_{A}, V_{B}, and V_{C} are also interchangeably referred to as A, B, and C signals, respectively.

A clock recovery circuit may take AB, BC, and CA differential signals and recover the clock whenever first switching happens on A, B, and C signals. Here, AB differential signal represents the difference between signals A and B (i.e., A-B). BC differential signal represents the difference between signals B and C (i.e., B-C), and CA differential signal represents the difference between signals C and A (i.e., C-A). However, skew difference between signals A, B, and/or C may negatively impact the differential data as well as recovered clock at the receiver because skew may not be tractable. To reduce such intra-skew between signals A, B, and/or C is challenging because interconnect carrying these signals may have to be matched to the channel including packages for all of the three wires.

In one embodiment, Rx 304 includes a skew tolerant clock recovery circuit including a comparator unit to receive the three data signals (i.e., A, B, and C signals) with respective clock signals embedded in the at least three data signals. The comparator unit forms the Analog Front End (AFE) of the Rx 304. In one embodiment, the comparator unit provides first (A_{clk}), second (B_{clk}), and third (C_{clk}) clock signals.

In one embodiment, Rx 304 comprises a delay unit (i.e., clock delay unit) coupled to the comparator unit. In one embodiment, the delay unit receives the first, second, and third clock signals to generate delayed versions of the first, second, and third clock signals, respectively. In one embodiment, Rx 304 further comprises a plurality of clock recovery units (CRUs), each of which is coupled to the delay unit and the comparator unit. In one embodiment, the plurality of clock recovery units are used to recover the embedded clock signals.

An interconnect can be based on 3-Phase symbol encoding technology capable of delivering 2.28 bits per symbol over three-wire trios to realize high speed data transmission objectives. A link of the interconnect can be a connection between two devices and can include at least one lane. A lane can include two complementary lane modules communicating via three-line, point-to-point lane interconnects. A line can refer to an interconnect wire used to connect a driver to a receiver. Three lines can be used, in such systems, to create a lane interconnect. Such an interconnect can he utilized, for instance, in mobile applications to facilitate connection of cameras and displays to a host processor, among other uses and applications.

A three-wire differential link lane can be implemented using a group of three wires. A clock signal can be embedded in signals sent over a three-line link. Within a three-wire lane, two of the three wires can be driven to opposite levels; the third wire is terminated to a mid-level (at either one end or both ends), and the voltages at which the wires are driven can change at every symbol. A wire state can refer to the combination of signal levels driven on the three lines of a lane.

Multiple bits can be encoded into each symbol epoch, with the data rate reaching approximately ˜2.28× the symbol rate without any additional overhead for line coding (e.g., 8b10b). Clock timing can be encoded into each symbol. This can be facilitated by causing the combination of voltages driven onto the wires to change at every symbol boundary. This simplifies clock recovery.

In some implementations, a master/slave paradigm can be provided. For instance, a synchronous connection can be provided between master and slave. A link utilizing three-phase symbol encoding technology can include a high-speed signaling mode for fast-data traffic and a low-power signaling mode for control purposes. In some instances, a low-power escape mode can be used for low speed asynchronous data communication. High-speed data communication can appear in bursts with an arbitrary number of payload data bytes. In one embodiment, a high-speed mode can provide that each lane is terminated on both sides and driven by a low-swing, 3-Phase signal. In low-power mode all wires may be operated single-ended and non-terminated. To minimize electromagnetic interference (EMI), the drivers for this mode can be slew-rate controlled and current limited.

Three-phase symbol encoding can result in six wire states, including three positive polarity wire states and three negative polarity wire states. The six driven wire states can be referred to as: +x, −x, +y, −y, +z, and −z. The positive polarity wire states can have the same wires driven as the corresponding negative polarity states, but the polarity is opposite on the driven pair of wires. For example: the +x wire state can be defined as A being driven high and B driven low, while the −x wire state is B driven high and A driven low. The “undriven” conductor can be undriven when operating at lower symbol rates, or can actually be driven by a termination at a voltage half way between the highest and lowest driven levels (e.g., a mid-voltage level) if operating at higher symbol rates.

In three-phase symbol encoding, state-transition can take place at every symbol boundary to encode the clock timing within the symbol. With six possible wire states, five possible state transitions are manifest from a present wire state to a next wire state (such as outlined in the example of Table 1). Symbol values can be defined by the change in wire state values from one unit interval to the next (e.g., based on the state transition on the lane). With the lane capable of possessing five distinct symbols, more than two bits of information (log 2(5)=2.3219 bits) can be encoded into each symbol. Seven consecutive symbols can be used to transmit 16 bits of information.

Turning to, a simplified block diagram is illustrated of an example lane module 400. A PHY configuration can include one or more lane modules, each equipped to communicate via three lines to a complementary device at the other side of the lane. Each lane module can support one or more high-speed functions utilizing three interconnect wires simultaneously, one or more single-ended low-power functions operating on each of the interconnect wires individually, as well as control and interface logic 405. A lane control and interface logic block 405 can control I/O functions and interface with a high layer protocol logic unit to determine the global operation of the lane module. High speed functions of a lane module can include a differential transmitter (HS-TX) 410 and a differential receiver (HS-RX) 415.

In some implementations, each link can have a master and a slave side. The master can provides the high-speed data signals to each lane and serve as the main data source. The slave can receive the data signals at the lanes and serve as the main data sink. The main direction of data communication, from source to sink, can be denoted as the forward direction. Data communication in the opposite direction can be referred to as reverse transmission.

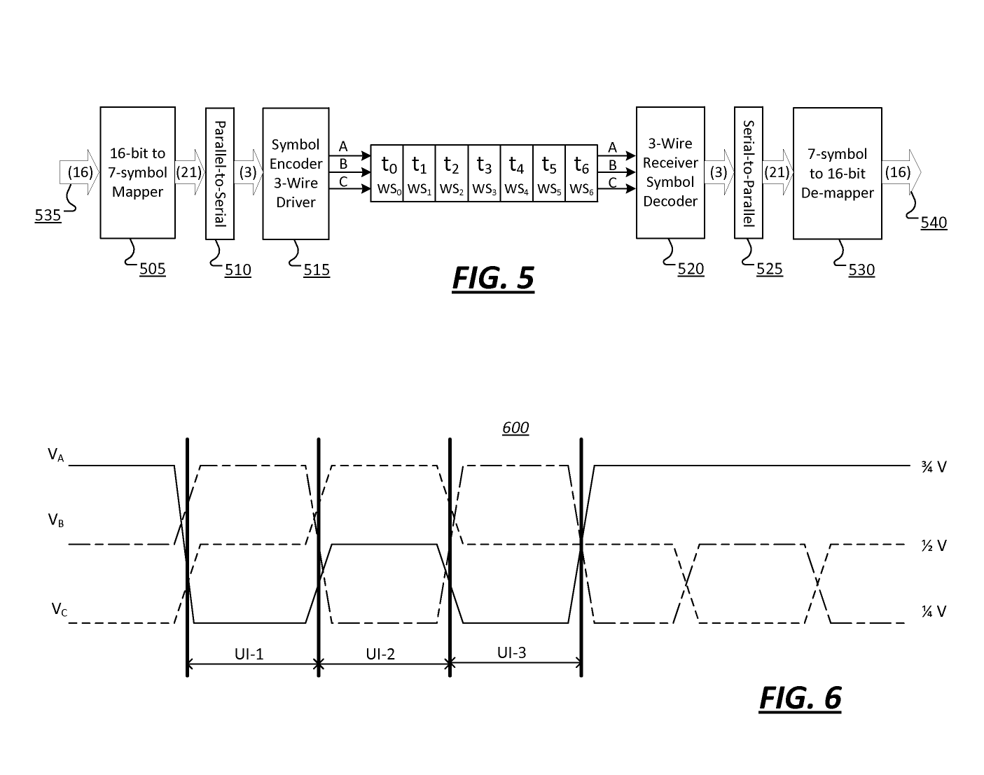

Turning to FIG. 5, a simplified block diagram 500 is shown illustrating processes (e.g., 505, 510, 515, 520, 525, 530) involved in the transmission (e.g., at 535) of 16-bit data from a transmitter in a master to the reception (e.g., at 540) of 16-bit data at the slave device. 16-bit words at the transmitter can be converted to seven channel symbols by a Mapper (e.g., at 505). The seven symbols can then be serialized (e.g., 510) and sent one symbol at a time to a Symbol Encoder and three-wire driver 515, which drives the three signals of the lane (A, B and C lines) at the transmitting end. At the receiving end, there three differential receivers can receive A minus B, B minus C, and C minus A. The digital outputs of the differential receivers can connect to a Symbol Decoder and clock recovery circuit 520. The output of the Symbol Decoder can be fed to a serial-to-parallel converter 525, and every group of 7 symbols output by the Symbol Decoder can be presented to the De-Mapper where they arc converted back to a 16-bit word (e.g., at 530).

A Mapper can convert a 16-bit data unit to be transmitted into a group of seven transmitted symbols. On the other hand, a De-Mapper can convert a group of 7 received symbols into a 16-bit data unit. A parallel to serial converter can accept a group of 7 symbols from the Mapper and present one symbol at a time to the Symbol Encoder. A serial to parallel converter can accepts one symbol at a time from the Symbol Decoder and present a group of 7 symbols to the De-Mapper. A Symbol Encoder can convert one symbol into a wire state to be sent over the lane based on the present three-bit symbol value and the wire state that was transmitted in the previous UI. A Symbol Decoder can compute a received symbol value based on the wire state received in the present UI and the wire state received in the previous UI.

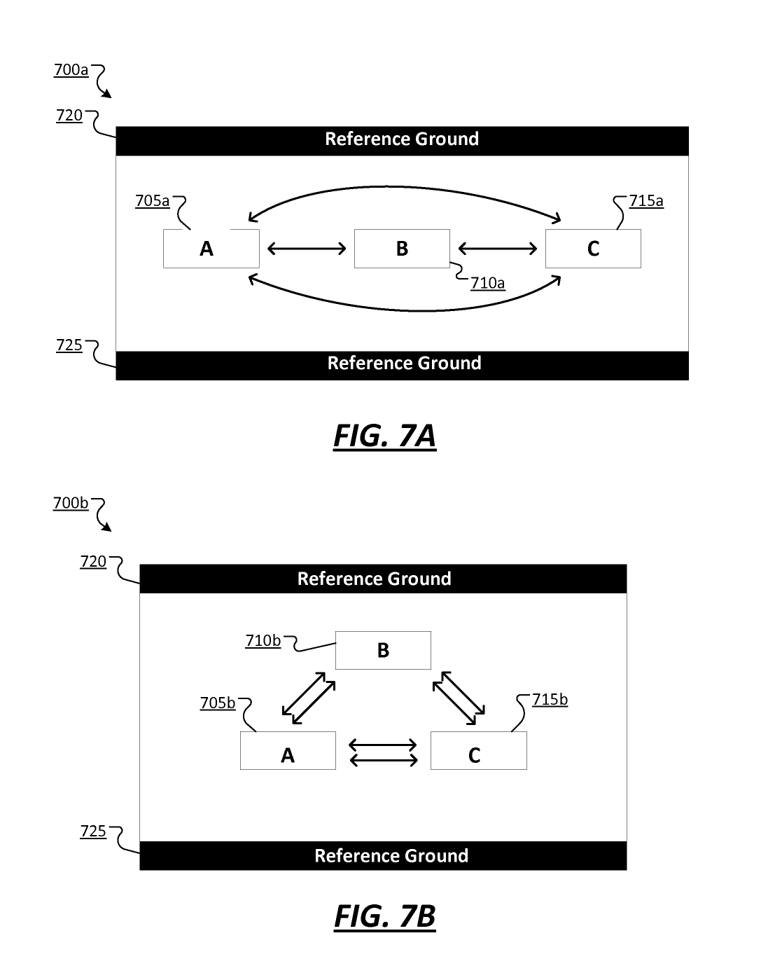

FIG. 6 illustrates a plot 600 showing an example of the three signal-trio. Here, x-axis is time and y-axis is voltage. The three signals (e.g., A, B, and C) can have respective voltage levels of V_{A}, V_{B}, and V_{C}. Further, in some implementations, voltages on signals A, B, and C can toggle between ¾ V, ½ V and ¼ V, among other examples. In each Unit Interval (UI), voltages V_{A}, V_{B}, and V_{C} of signals A, B, and C, respectively, can change. Here, three UIs are labeled as UI-1, UI-2 and UI-3. In one embodiment, for each UI, the embedded clock is recovered and used to sample the data.

A three-phase differential signal encoding solution can be utilized to increase the efficiency and data rate of a single link. Differential signaling can exhibit better common mode noise cancellation characteristics than single-ended signaling. Differential signaling can also result in a virtual reference ground, which can stabilize the signal propagation regardless of return path.

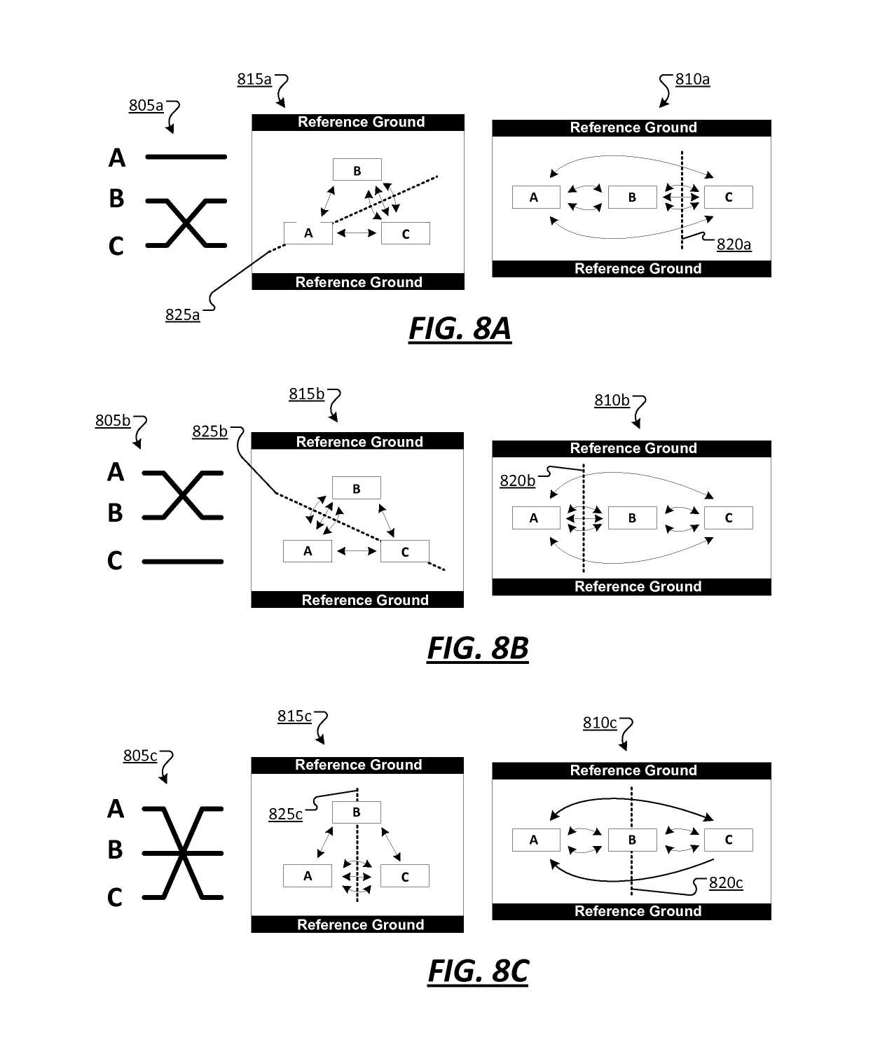

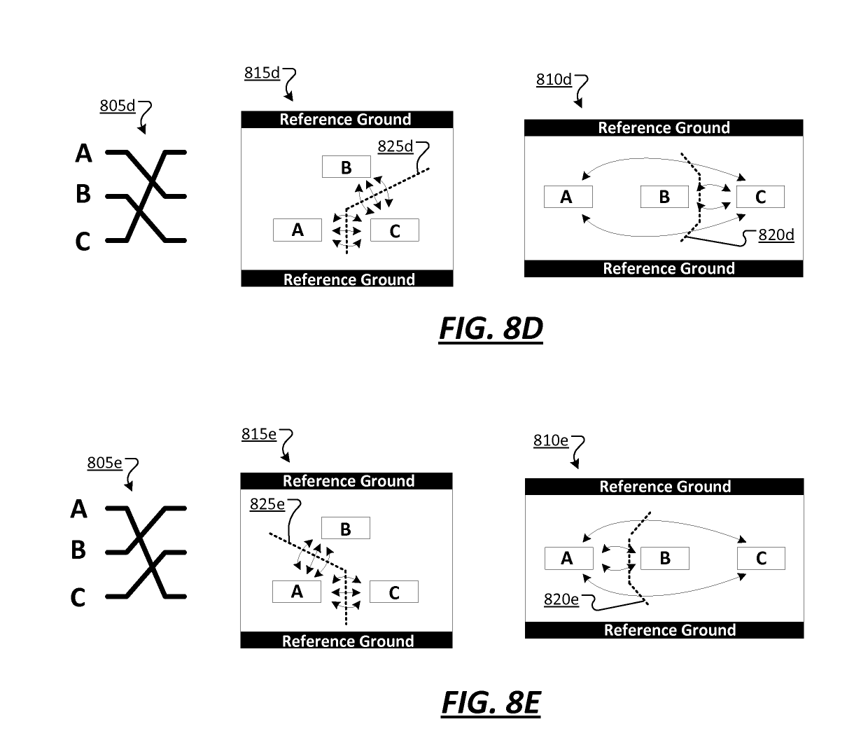

A conventional three-wire lane is shown in the diagram 700a of FIG. 7A. FIG. 7A represents a cross-sectional view of a lane. Three lines 705a, 710a, 715a are provided between reference ground conductors 720, 725. The three lines 705a, 710a, 715a form a three-wire lane, with combinations of clock signal levels being driven on the lines 705a, 710a, 715a to realize one of six wire states for the lane. In the example of FIG. 7A, the three lines are laid 705a, 710a, 715a substantially side-by-side, with line 710a set in between lines 705a and 715a. In such an arrangement, lines 705a and 715a are each more closely coupled with line 710a by virtue of each wire 705a, 715a being in closer proximity to line 710a than each other. For instance, if each wire 705a, 710a, 715a is one unit measurement in width and the distances between wires 705a and 710a and wires 710a and 715a are also one unit, then the distance between wires 705a and 715a would be three units (i.e., multiple time wider than the distance between these wires 705a, 715a and wire 710a). While some benefits may be realized utilizing the orientation illustrated in the example of FIG. 7A, such an orientation can result in crosstalk noise, skew, and high electromagnetic interference (EMI), jeopardizing some of the benefits provided through a three-phase signaling solutions.

FIG. 7B illustrates a cross-sectional view of a physical three-wire lane configuration that can serve as an alternative to the embodiment described in FIG. 7A. For instance, a triangular configuration can be provided. A three-wire link can include wires 705b, 710b, 715b positioned within a dielectric material between reference voltage conductors 720, 725 such that each wire 705b, 710b, 715b is equidistant from each of the other wires in the three-wire set. This arrangement can manifest itself as an equilateral triangle arrangement, such as shown in the example of FIG. 7B. In one implementation, two of the wires (e.g., 705b, 710b) can be oriented equidistant from reference ground conductor 725. The third wire (e.g., 715c) can be positioned approximately the same distance from the other reference ground conductor 720. Other implementations can orient the triangular cross-sectional layout of the wires in alternative positions between the reference ground conductors 720, 725.

Solutions adopting a configuration similar to that outlined in the example of FIG. 7B can exhibit electrical conditions superior to those exhibited in conventional three-wire implementations, such as those exhibiting an orientation similar to that shown and described in connection with the example of FIG. 7A. With the wires positioned equidistant to every other wire in the three-wire set, the three-wire pairs in the group shown in FIG. 7B can be equally coupled. This strong coupling can exhibit substantial improvements in noise immunity, skew impact, and lower EMI. For instance, through the topology of the example of FIG. 7B, equal coupling between pairs AB, BC, AC can be realized, resulting in cancellation of noise and skew difference from interference introduced by the wire outside the given pair. On the other hand, in the example of FIG. 7A, the AB (705a, 710a) and BC (710a, 715a) wire pairs have the same amount of coupling, while the coupling of the AC pair (705a, 715a) is different. Due to this difference, a mismatch results in the flight time of each pair and noise sensitivity can increase dramatically. Further, the topology shown in FIG. 7A does not guarantee the stable virtual reference ground for differential operation.

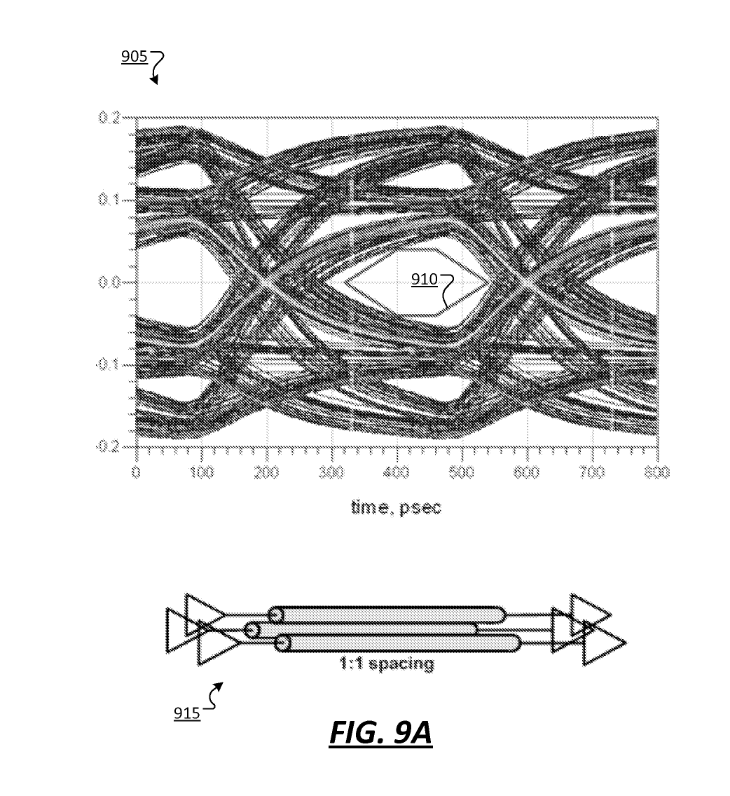

In a differential signal, a virtual reference ground can manifest. Turning to FIGS. 8A-8E, five wire state transitions 805a-e are represented together with the signaling and virtual reference grounds manifested in conventional three-wire lanes as compared with the signaling and virtual reference grounds manifested in improved three-wire lanes. For instance, FIG. 8A represents a first wire state transition 805a and cross sectional diagrams of a conventional, linear three-wire lane configuration 810a and an improved, triangular three-wire lane configuration 815a. In each diagram (e.g., 810a-815a), a respective virtual reference ground (820a, 825a) is shown, which is generated from the electrical signals on the wires during the transition (e.g., 805a). In the case of FIG. 8A, a transition 805a involves transmission wires A staying in a “high” voltage level, line B transitioning from a “mid” to a “low” voltage level, and line C transitioning from the “low” to the “mid” value. In the conventional topology, a virtual reference ground 820a develops between lines B and C during the transition 805a. The virtual reference ground 820a is asymmetrically disposed among the three wires. This can lead to a characteristic impedance mismatch between the wires. For instance, the impedance mismatch can be derived from the formula:

Z₀=\sqrt{L/C}

where the distance of the virtual ground from a wire defines the electrical coupling capacitance parameter C and L equals the inductance. The capacitance C and inductance L of each wire is a set characteristic defined by how the wires of the link are “stacked” in the physical link. In the example of 810a, the impedance for lines B and C during the transition will be roughly equally during the transition, based on each being equally coupled to the virtual reference ground 820a. Line A, on the other hand, is further away from the virtual reference ground 820a and thus has a different C value and impedance Z₀ value than lines B and C. Additionally, because line A is closer to line B than line C, the virtual reference ground 820a is unbalanced and becomes noise source. Accordingly, in this example, crosstalk experienced at line A will be more greatly influenced by line B than line C and can result in noise and skew.

Continuing with the example of FIG. 8A, an improved topology (shown at 815a) can exhibit a virtual reference ground 825a that is equidistant from the wires (B and C) driving the transition 805a and aligned with wire A that maintains its signal during the transition. As a result, the virtual reference ground 825a is symmetrically disposed in the three-wire grouping shown in diagram 815a. A virtual reference ground manifests as an area between a differential pair where the electrical potential remains constant during the signal pattern on the differential wires. When a wire is aligned with the virtual reference ground, this wire is operated as the return path for the other wires without any noise interruption. Accordingly, with the virtual reference ground 825a aligned with wire A, wire A can effectively serve as the return path for the differential signal at transition 805a. Further, as wire A is equidistant from wires B and C, cross talk of the wires is exhibited equally on wire A, and as the signals of wires B and C are 180 degrees out of phase, the crosstalk cancel out at wire A, eliminating noise from the transition 805a.

FIGS. 8B-8E show the remaining wire state transitions in a set of five wire state transitions between six wire states. FIG. 8B illustrates a transition 805b analogous to the transition 805a shown and described in FIG. 8A, but in the case of transition 805b, wire A transitions from high to mid, wire B transitions from mid to high, and wire C remains at low. A virtual reference ground (e.g., 820b, 825b) is manifest between wires A and B due to the voltage level transitions, with the virtual reference ground 820b again dividing the lane asymmetrically in the conventional topology (at 810b) but aligning symmetrically and in-line with wire C in the triangular topology, resulting in more stability in the example of 815b. Similar defects exist in the examples 810d, 810e of FIGS. 8D and 8E, with unbalanced virtual reference grounds 820d, 820e and crosstalk in the conventional topology. The triangular topology (at 815d, 815e) rectifies the deficiencies of the conventional topology in state transitions 805d, 805e, resulting in a virtual reference ground that is the same distance from each of the wires A, B, and C while retaining crosstalk balance for less EMI noise, high CM noise rejection, and less skew than would be experienced using the conventional topology illustrated in diagrams 810d, 810e. Indeed, in this example, the only transition where the conventional topology yields results comparable to the triangular topology is in the example of FIG. 8C for state transition 805c. As the center wire B in topology 810c stays mid while the two wires (A and C) flanking it go low-high and high-low respectively, the virtual reference ground 820c symmetrically bisects the three-wire grouping and centers on wire B, making wire B the return path. However, similar results are manifest in the triangular topology during transition 805c, with a balanced virtual reference ground 825c manifesting that is symmetrical and aligned with the stable wire B (as shown in diagram 815c).

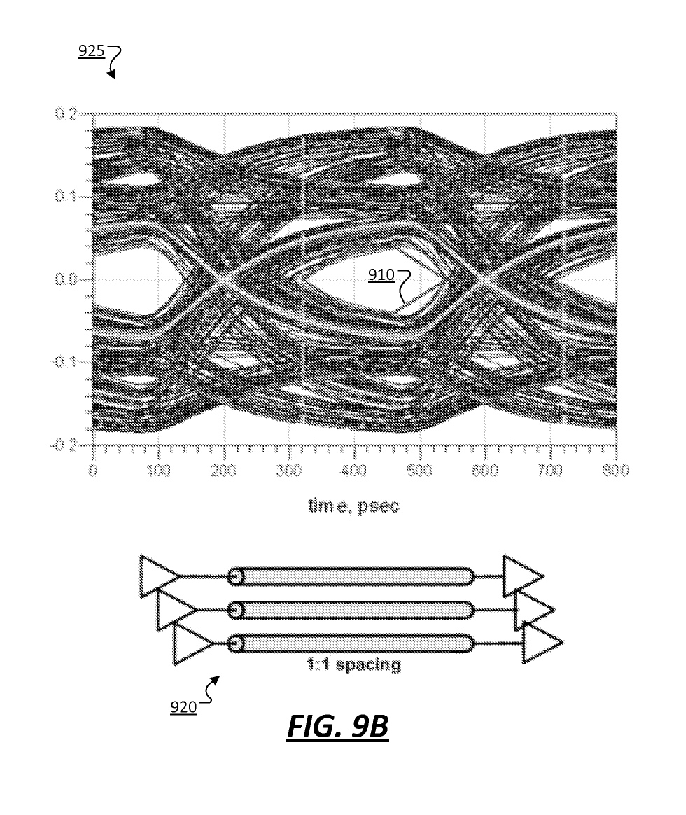

FIGS. 9A-B illustrate a comparison between the signal quality (shown in FIG. 9A) resulting from a three-wire three phase encoded link utilizing a triangular topology similar to FIG. 7B with the signal quality (shown in FIG. 9B) resulting from a three-wire, three phase encoded link utilizing a linear topology similar to that shown in FIG. 7A. In FIG. 9A, an eye diagram 905 is presented, showing the signals (plotted over time) as measured at the input of a receiver. Target 910 represents a desired “eye” manifest during the signaling on a three-wire lane. As shown in eye diagram 905, a three-wire lane (e.g., with 100 ohm termination) utilizing a triangular topology (e.g., similar to that illustrated in FIG. 7B and perspective view 915) can meet the target, while a similarly-spaced linear topology (similar to FIG. 7A and perspective view 920) manifests a deficient eye (shown in eye diagram 925).

In some implementations, by maintaining equal coupling between all three single ended signals (e.g., as in the triangular orientation described above), differential signals see the same impedance, minimizing the reflections as shown. Conventional stack-up designs, however, result in unsymmetrical coupling between the three signals causing differential impedance mismatch further degrading the channel margin. Additionally, uneven coupling can result in the conventional stack-up topologies exhibiting as a noise source instead of the stable return path as realized through the described triangular topology that provides equal coupling. Such equal coupling results in reduced noise and skew, as well as lower EMI and radio frequency interference (RFI), allowing very stable signal transitions on the link, among other example advantages.

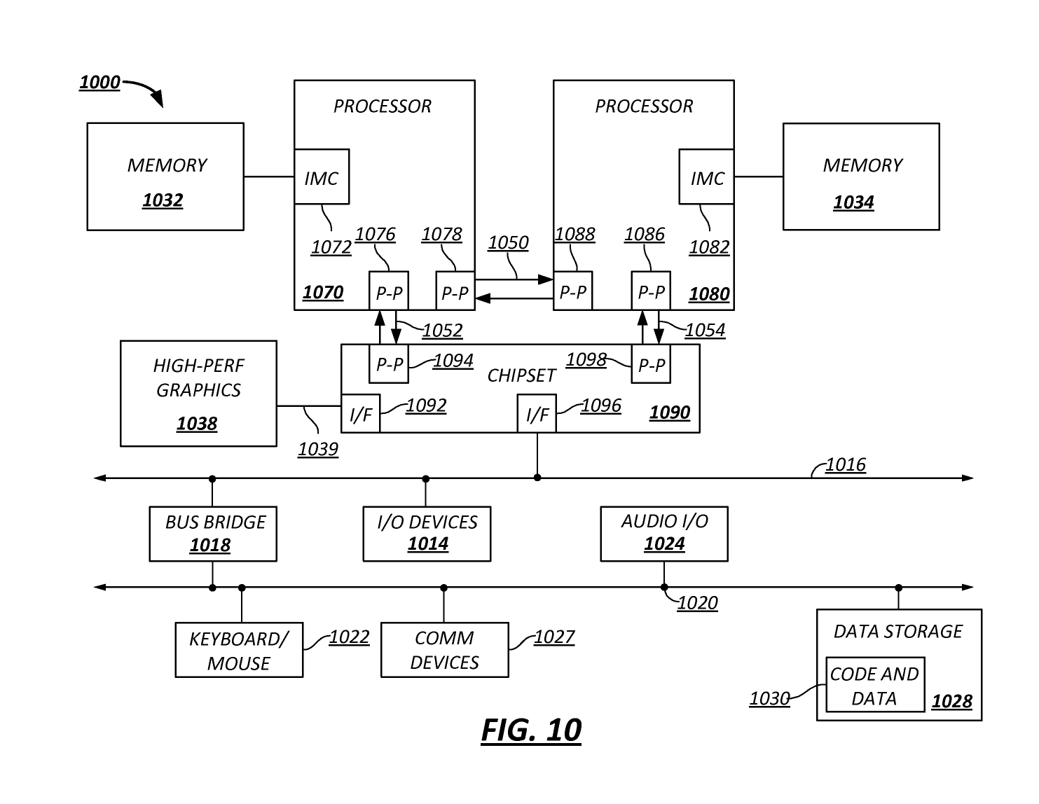

In some systems, the triangular three-wire physical lanes described above can be utilized in an implementation of a MIPI C-PHY physical layer, or alternatively, in the implementation of a physical layer of another interconnect protocol. Indeed, it should be appreciated that the components and features described herein can be incorporated in any variety of computing devices and systems, including mainframes, server systems, personal computers, mobile computers (such as tablets, smartphones, personal digital systems, etc.), smart appliances, gaming or entertainment consoles and set top boxes, among other examples. For instance, referring to FIG. 10, a block diagram is shown of an example system 1000 in accordance with at least one embodiment. As shown in FIG. 10, multiprocessor system 1000 is a point-to-point interconnect system, and includes a first processor 1070 and a second processor 1080 coupled via a point-to-point interconnect 1050. Each of processors 1070 and 1080 may be some version of a processor. In one embodiment, 1052 and 1054 are part of a serial, point-to-point coherent interconnect fabric, such as a high-performance architecture.

While shown with only two processors 1070, 1080, it is to be understood that the scope of the present invention is not so limited. In other embodiments, one or more additional processors may be present in a given processor.

Processors 1070 and 1080 are shown including integrated memory controller units 1072 and 1082, respectively. Processor 1070 also includes as part of its bus controller units point-to-point (P-P) interfaces 1076 and 1078; similarly, second processor 1080 includes P-P interfaces 1086 and 1088. Processors 1070, 1080 may exchange information via a point-to-point (P-P) interface 1050 using P-P interface circuits 1078, 1088. As shown in FIG. 10 IMCs 1072 and 1082 couple the processors to respective memories, namely a memory 1032 and a memory 1034, which may be portions of main memory locally attached to the respective processors.

Processors 1070, 1080 each exchange information with a chipset 1090 via individual P-P interfaces 1052, 1054 using point to point interface circuits 1076, 1094, 1086, 1098, Chipset 1090 also exchanges information with a high-performance graphics circuit 1038 via an interface circuit 1092 along a high-performance graphics interconnect 1039.

A shared cache (not shown) may be included in either processor or outside of both processors; yet connected with the processors via P-P interconnect, such that either or both processors' local cache information may be stored in the shared cache if a processor is placed into a low power mode.

Chipset 1090 may be coupled to a first bus 1016 via an interface 1096. In one embodiment, first bus 1016 may be a Peripheral Component Interconnect (PCI) bus, or a bus such as a PCI Express bus or another third generation I/O interconnect bus, although the scope of the present invention is not so limited.

As shown in FIG. 10, various 1/O devices 1014 are coupled to first bus 1016, along with a bus bridge 1018 which couples first bus 1016 to a second bus 1020. In one embodiment, second bus 1020 includes a low pin count (LPC) bus. Various devices are coupled to second bus 1020 including, for example, a keyboard and/or mouse 1022, communication devices 1027 and a storage unit 1028 such as a disk drive or other mass storage device which often includes instructions/code and data 1030, in one embodiment. Further, an audio I/O 1024 is shown coupled to second bus 1020. Note that other architectures are possible, where the included components and interconnect architectures vary. For example, instead of the point-to-point architecture of FIG. 10, a system may implement a multi-drop bus or other such architecture.

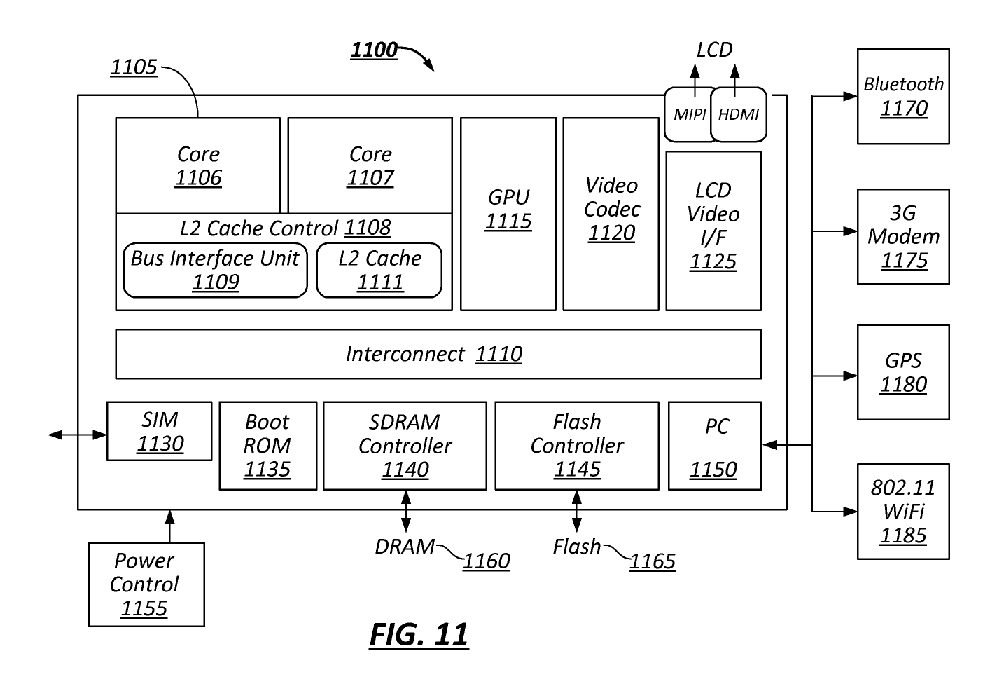

Turning next to FIG. 11, an embodiment of a system on-chip (SOC) design in accordance with the inventions is depicted. As a specific illustrative example, SOC 4400 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 4400 includes 2 cores—4406 and 4407. Similar to the discussion above, cores 4406 and 4407 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 4406 and 4407 are coupled to cache control 4408 that is associated with bus interface unit 4409 and L2 cache 4411 to communicate with other parts of system 4400. Interconnect 4410 includes an on-chip interconnect, such as an IOSF, AMBA, or other interconnect discussed above, which potentially implements one or more aspects of described herein.

Interconnect 4410 provides communication channels to the other components, such as a Subscriber Identity Module (SIM) 4430 to interface with a SIM card, a boot rom 4435 to hold boot code for execution by cores 4406 and 4407 to initialize and boot SOC 4400, a SDRAM controller 4440 to interface with external memory (e.g. DRAM 4460), a flash controller 4445 to interface with non-volatile memory (e.g. Flash 4465), a peripheral control 4450 (e.g. Serial Peripheral Interface) to interface with peripherals, video codes 4420 and Video interface 4425 to display and receive input (e.g. touch enabled input), GPU 4415 to perform graphics related computations, etc. Any of these interfaces may incorporate aspects of the invention described herein.

In addition, the system illustrates peripherals for communication, such as a Bluetooth module 4470, 3G modem 4475, GPS 4485, and WiFi 4485. Note as stated above, a UE includes a radio for communication. As a result, these peripheral communication modules are not all required. However, in a UE some form a radio for external communication is to be included.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can he used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

One or more embodiments may provide an apparatus, a system, a machine readable storage, a machine readable medium, hardware- and/or software-based logic (e.g., a lane monitor), and a method to convert a stream of binary data into a stream of symbols according to a three-phase encoding scheme and send the symbols on a physical link. A mapper can convert the stream of binary data and a transmitter can send the symbols. The link can include one or more lanes, each lane comprising a set of three conductors. The set of three conductors are to be oriented so that each conductor in the set is equidistant from the other two conductors in the set.

In at least one example, the set of three conductors are to be oriented in a triangular topology.

In at least one example, the three-phase encoding scheme defines a set of five symbols and each symbol in the set of five symbols corresponds to a wire state transition on the lane.

In at least one example, the encoding scheme defines six wire states and each of the five symbols corresponds to a respective one of five transitions between the six wire states.

In at least one example, each of the six wire states correspond to a respective combination of differential voltages to be drive on the three conductors. In each combination, a respective one of the wires in the set is driven to a first voltage level, another of the wires in the set is driven to a second voltage level, and remaining one of the wires in the set is driven to a third voltage level.

In at least one example, the first voltage level includes a low voltage level, the second voltage level includes a mid voltage level, and the third voltage level includes a high voltage level.

In at least one example, a corresponding virtual reference ground is to be generated during each of the wire state transitions, and each of the virtual reference grounds includes a symmetrical virtual reference ground.

In at least one example, sixteen bits are to be encoded into seven symbols.

One or more embodiments may provide an apparatus, a system, a machine readable storage, a machine readable medium, hardware- and/or software-based logic (e.g., a lane monitor), and a method to receive data over a physical link, where the data is to comprise a stream of symbols, the link is to comprise one or more lanes, each lane is to comprise a set of three conductors, the set of three conductors are to be oriented in a triangular orientation and are equally coupled in the orientation, and the stream of symbols is to comprise differential signals sent on the set of three conductors. The stream of symbols is translated into a binary data stream. A receiver can receive the data and a de-mapper can translate the stream of symbols into a binary data stream.

In at least one example, the set of three conductors are to be oriented so that each conductor in the set is equidistant from the other two conductors in the set.

In at least one example, the symbols are encoded according to a three-phase symbol encoding scheme.

In at least one example, each symbol is to be decoded into two or more bits.

In at least one example, the link comprises a MIPI C-PHY physical layer.

One or more embodiments may provide an apparatus that includes a physical link that includes one or more lanes. Each lane can include at least one reference ground conductor and a set of three conductors embedded in a dielectric, where the set of three wires are disposed in the dielectric so that each conductor in the set is equidistant from the other two conductors in the set.

In at least one example, each lane comprises two reference ground conductors.

In at least one example, each lane is to carry data steam encoded according to a three-phase differential symbol encoding scheme.

In at least one example, a first and second device can be connected using the physical link.

In at least one example, the first device, second device, and link are included in a mobile computing device.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a mapper to convert a stream of binary data into a stream of symbols according to a three-phase encoding scheme;
a transmitter to send the symbols on a physical link, wherein the link is to comprise one or more lanes, each lane is to comprise a set of three conductors, and the set of three conductors are to be oriented so that each conductor in the set is equidistant from the other two conductors in the set.

2. The apparatus of claim 1, wherein the set of three conductors are to be oriented in a triangular topology.

3. The apparatus of claim 1, wherein the three-phase encoding scheme defines a set of five symbols and each symbol in the set of five symbols corresponds to a wire state transition on the lane.

4. The apparatus of claim 3, wherein the encoding scheme defines six wire states and each of the five symbols corresponds to a respective one of five transitions between the six wire states.

5. The apparatus of claim 4, wherein each of the six wire states correspond to a respective combination of differential voltages to be drive on the three conductors.

6. The apparatus of claim 5, wherein in each combination, a respective one of the wires in the set is driven to a first voltage level, another of the wires in the set is driven to a second voltage level, and remaining one of the wires in the set is driven to a third voltage level.

7. The apparatus of claim 6, wherein the first voltage level comprises a low voltage level, the second voltage level comprises a mid voltage level, and the third voltage level comprises a high voltage level.

8. The apparatus of claim 3, wherein a corresponding virtual reference ground is to be generated during each of the wire state transitions, and each of the virtual reference grounds comprises a symmetrical virtual reference ground.

9. The apparatus of claim 1, wherein sixteen bits are to be encoded into seven symbols.

10. An apparatus comprising:
a receiver to receive data over a physical link, wherein the data is to comprise a stream of symbols, the link is to comprise one or more lanes, each lane is to comprise a set of three conductors, the set of three conductors are to be oriented in a triangular orientation and are equally coupled in the orientation, and the stream of symbols is to comprise differential signals sent on the set of three conductors;
a de-mapper to translate the stream of symbols into a binary data stream.

11. The apparatus of claim 10, wherein the set of three conductors are to be oriented so that each conductor in the set is equidistant from the other two conductors in the set.

12. The apparatus of claim 10, wherein the symbols are encoded according to a three-phase symbol encoding scheme.

13. The apparatus of claim 12, wherein each symbol is to be decoded into two or more bits.

14. The apparatus of claim 10, wherein the link comprises a MIPI C-PHY physical layer.

15. An apparatus comprising:
a physical link comprising:
one or more lanes, wherein each lane comprises:
at least one reference ground conductor;
a set of three conductors embedded in a dielectric, wherein the set of three wires are disposed in the dielectric so that each conductor in the set is equidistant from the other two conductors in the set.

16. The apparatus of claim 15, wherein each lane comprises two reference ground conductors.

17. The apparatus of claim 15, wherein each lane is to carry data steam encoded according to a three-phase differential symbol encoding scheme.

18. A system comprising:
a first device;
a second device; and
a link connecting the first device and the second device, wherein the link comprises a plurality of lanes, and each lane comprises a respective set of three conductors oriented in a triangular orientation so that each conductor in the set is equidistant from the other two conductors in the set;
wherein the first device is to:
convert a stream of binary data into a stream of symbols according to a three-phase encoding scheme; and
send the symbols to the second device on one or more lanes of the link

19. The system of claim 18, wherein the second device is to receive the symbols and translate the symbols into the stream of binary data.

20. The system of claim 18, wherein the first device, second device, and link are included in a mobile computing device.
